(19) United States
(12) Patent Application Publication
(10) Pub. No.: US 2006/0273994 A1
(43) Pub. Date: Dec. 7, 2006

(54) Electroluminescence display and pixel array thereof

(75) Inventor: Wein-Town Sun, Longtan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/332,925

(22) Filed: Jan. 17, 2006

(30) Foreign Application Priority Data
Jun. 1, 2005 (TW) 94118081

(51) Int. Cl. G09G 3/30

(52) U.S. Cl. 345/76

(57) ABSTRACT

A pixel array of electroluminescence display including a number of data lines, a scan line, and a number of pixels is provided. The pixels are respectively electrically connected to the scan line and the corresponding data lines. Each pixel respectively has a storage capacitor. The storage capacitors have different capacitance values.

This application claims the benefit of Taiwan application Serial No. 94118081, filed Jun. 1, 2005, the subject matter of which is incorporated herein by reference.

### BACKGROUND OF THE INVENTION

1. Field of the Invention

The invention relates in general to an electroluminescence display, and more particularly to a pixel array with different storage capacitance values.

2. Description of the Related Art

Since the luminance generated by an electroluminescent device is greater than the current that flowing through, the change in the current would directly affect the uniformity of the luminance of the electroluminescent device.

Referring to FIG. 1, a diagram showing the structure of a conventional pixel is shown. Pixel 100 has a TFT Tdr for driving purpose, a TFT Tsw used as a switch, a storage capacitor Cs and an electroluminescent device. The electroluminescent device can be an organic light emitting diode (OLED) for instance. After a scan signal S starts the TFT Tsw via a scan line SL, a pixel voltage (not shown in FIG. 1) is transmitted to a point A of the storage capacitor Cs via a data line DL and the TFT Tsw and enables the TFT Tdr to flow through a driving current I corresponding to the pixel voltage. The driving current I flows through the OLED to generate the luminance corresponding to the pixel voltage. Meanwhile, the storage capacitor Cs would storage the capacitor voltage corresponding to the pixel voltage.

When the scan signal S is shifted to a low voltage level from a high voltage level, for example the scan signal S is reduced from +9V to −6V, and turns off the TFT Tsw via the scan line SL, the −6 V changes the voltage magnitude at point A via a parasitic capacitor Cgs of the TFT Tsw. Since the capacitor voltage affects the magnitude of the driving current I flowing through the OLED when the TFT Tdr turns off, voltage change in the point A would affect the luminance of the OLED in consequence. The phenomenon that voltage level at point A changes along with the change in the voltage level of the scan signal S is called the feed-through effect or the kick back effect. Such effect affects pixel 100 in the way that after the TFT Tsw is turned off, the low voltage of the scan signal S is coupled to the point A via the parasitic capacitor Cgs and changes the cross-voltage Vc′ of the capacitor accordingly. The change in the cross-voltage Vc of the capacitor prevents the driving current I from achieving the predetermined level, and eventually affects the luminance of the OLED.

The above feed-through effect would not affect the image quality if the effect is uniformly distributed on the luminance of each pixel 100 of the pixel array. However, due to the resistance of the scan line and the parasitic capacitor existing between the electrodes and the scan line, the RC delay of the scan signal would arise. Therefore, when the scan signal S is transmitted to the pixel 100 at the terminate end of the scan line, the waveform of the scan signal S would be distorted due to the RC delay in the circuit during the transmission of the scan signal S. Referring to FIG. 2, a diagram showing the RC delay of the scan signal is shown. As shown in FIG. 2, display panel 102 has N pixels 100(1)˜100(N), N is a positive integer. The N pixels 100 are electrically connected to the same scan line SL. The leftmost pixel 100(1) of the display panel 102 being close to the input end of the scan signal S implies that the scan signal S received by the pixel 100(1) is most close to an ideal square wave and that the worst distortion occurs to the scan signal S at the rightmost pixel 100(N) of the display panel 102.

When the scan signal S is instantly shifted to a low voltage level, for example −6V, the TFT Tsw of the leftmost pixel 100(1) would be instantly turned off because the scan signal S is most close to the ideal square wave. Consequently, the low voltage level of the scan signal S would be instantly coupled to the point A, causing the cross-voltage Vc′ of the capacitor of the pixel 100(1) to decrease.

Due to the distortion in the waveform of scan signal S, the TFT Tsw of the rightmost pixel 100(N) of the display panel 102 would be turned off later than that of the leftmost pixel 100(1) of the display panel 102. In terms of the storage capacitor Cs of the rightmost pixel 100(N), the pixel voltage on the data line DL still has a very short to change the voltage on the storage capacitor Cs of the pixel 100(N) before the TFT Tsw is completely turned off. Therefore, on the same scan line SL, the voltage on the storage capacitor Cs of the rightmost pixel 100(N) might differ with the voltage on the storage capacitor Cs of the leftmost pixel 100(N) significantly. For example, despite the same voltage is inputted to pixels of the same row, the voltage level at point A of the rightmost pixel 100(N) would be higher than the voltage level at point A of the leftmost pixel 100(1) due to the distortion of the scan signal S. Consequently, for the pixel 100 in the same row, the luminance at the left hand side would be different from that at the right hand side.

### SUMMARY OF THE INVENTION

It is therefore the object of the invention to provide an electroluminescence display to resolve the non-uniformity of luminance due to the distortion in the waveform of the scan signal.

According to an object of the invention, an electroluminescence display is provided. The electroluminescence display includes a number of data lines, a scan line, a number of pixels, a scan driving circuit, and a data driving circuit. The scan line has an input end. Each pixel is electrically connected to the scan line and the corresponding data line and having a storage capacitor with a corresponding capacitance value different from those of the other pixels The scan driving circuit is for providing a scan signal to the scan line to drive the pixels accordingly. The data driving circuit is for providing a pixel data to the data lines. The pixel data are applied to the corresponding pixels as the scan signal is enabled.

According to another object of the invention, a pixel array of electroluminescence display is provided. The electroluminescence display includes a data driving circuit and a scan driving circuit. The pixel array includes a number of data lines, a scan line and a number of pixel arrays. The data lines are electrically connected to the data driving circuit. scan line is electrically connected to the scan driving circuit. The pixels are respectively electrically connected to the scan line and the corresponding data lines. Each pixel respectively has a storage capacitor. The storage capacitors have different capacitance values.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing the structure of a conventional pixel;

FIG. 2 is a diagram showing the RC delay of the scan signal;

FIG. 3 is a diagram showing the circuit structure of an LED display according to an embodiment of the invention;

FIG. 4 is a diagram showing an example of the circuit structure of a pixel array of FIG. 3;

FIG. 5 is a Pspice simulation result of voltage level change in point A according to a conventional method;

FIG. 6 is a Pspice simulation result of voltage level change in point A according to an embodiment of the invention.

FIG. 7 is a circuit diagram of an example of a current-driven pixel; and

FIG. 8 is a circuit diagram of another example of a current-driven pixel.

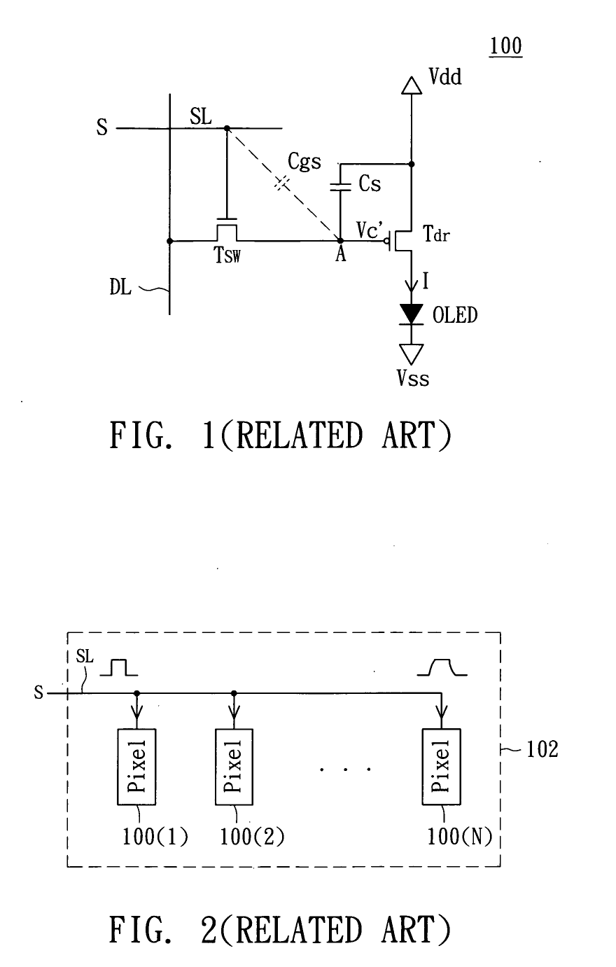

### DETAILED DESCRIPTION OF THE INVENTION

The invention provides an electroluminescence display and the pixel array thereof. The non-uniformity of luminance caused by the distortion in the waveform of a scan signal is compensated by the decreasing capacitance values of the storage capacitor at the input end of the scan signal of each pixel electrically connected to the same scan line. Each capacitance value of the storage capacitor is adjusted according to the corresponding change in the voltage of the storage capacitor caused by the distortion of the scan signal. At last, within the same pixel data, the differences between the voltages of the storage capacitors in the same row are mitigated, enabling the luminance of the pixels in the same row to be more uniform.

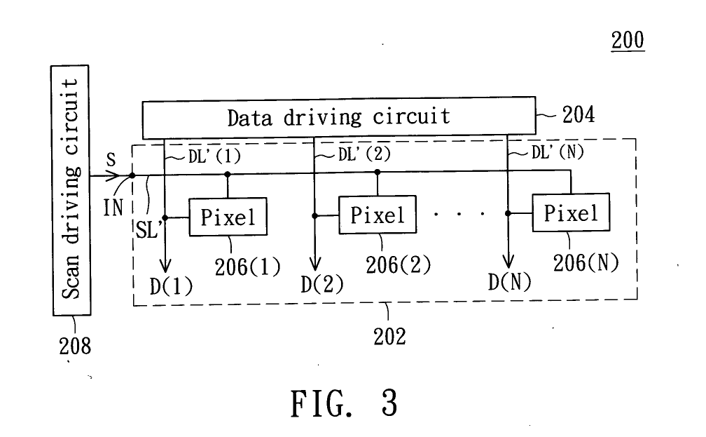

Referring to FIG. 3, a diagram showing the circuit structure of an LED display according to an embodiment of the invention is shown. Electroluminescence display 200 includes a pixel array 202, a data driving circuit 204 and a scan driving circuit 208. The pixel array 202 includes a number of data lines DL′(1)˜DL′(N), a scan line SL′ and a number of pixels 206(1)˜206(N), N is a positive integer. The scan driving circuit 208 is used to output a scan signal S to one end of a scan line SL′ (IN end of FIG. 3) to drive the pixels 206(1)˜206(N) accordingly. The data driving circuit 204 is used to output a number of pixel data D(1)˜D(N) to the corresponding data line DL′(1)˜DL′(N). The pixels 206(1)˜206(N) are electrically connected to the scan line SL′ and the corresponding data line DL′.

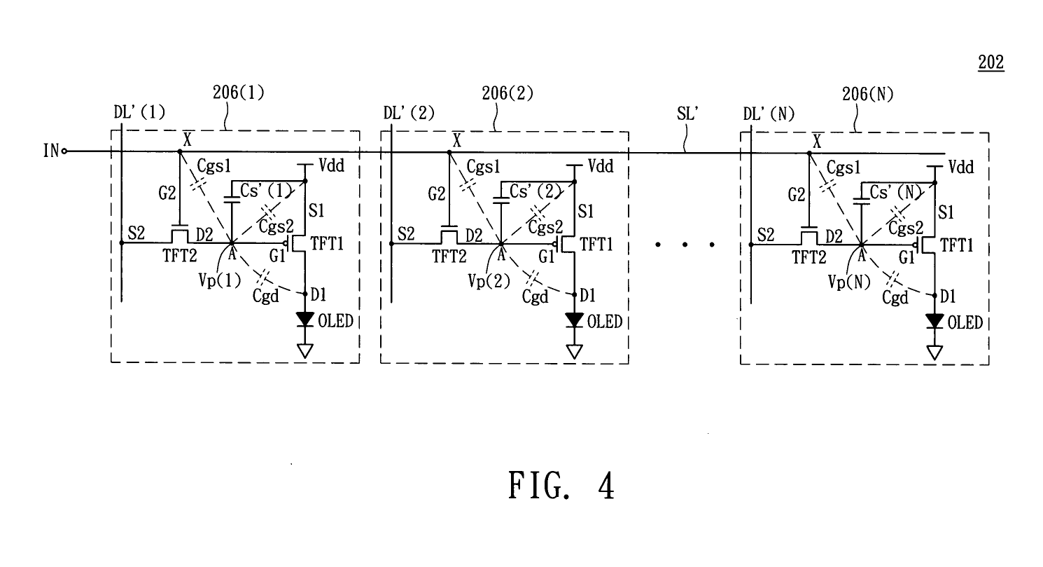

Referring to FIG. 4, a diagram showing an example of the circuit structure of a pixel array of FIG. 3 is shown. The pixels 206(1)˜206(N) are exemplified by a voltage driving method. Each of the pixels 206 includes a storage capacitor Cs′, an electroluminescent device, a switch device and a TFT. The storage capacitors Cs′(1)˜Cs′(N) respectively have different capacitance values. For example, the capacitance value of the storage capacitor Cs′(I) of the I-th pixel 206(I) of the pixels 206 is larger than the capacitance value of the storage capacitor Cs′(J) of the J-th pixel 206(J) of the pixels 206(1)˜206(N), 1≦I, J≦N, I<J, I and J are positive integers. That is, the capacitance value of the storage capacitor Cs' closer to the input end IN of the scan signal is larger than the capacitance value of the storage capacitor Cs' afar from the input end IN of the scan signal. The electroluminescent device can be a polymer OLED (PLED) or an OLED for instance. In the present embodiment, the electroluminescent device is exemplified by the OLED. The switch device has a first end, a second end and a control end. The switch device can be an N-type thin film transistor TFT2 for instance. The first end is a source S2, the second end is a drain D2, and the control end is a gate G2. In each pixel 206, the source S2 of the thin film transistor TFT2 is respectively electrically connected to the corresponding data line DL′, and the drain D2 of the thin film transistor TFT2 is respectively coupled to a constant voltage level via the corresponding storage capacitor Cs′. The constant voltage level can be a voltage Vdd or a Vss, or electrically connected to an upper level scan line (not shown in FIG. 4). In FIG. 4, the level of the constant voltage is labeled as voltage Vdd. The gate G2 of the thin film transistor TFT2 is electrically connected to the scan line SL′.

The above TFT can be a P-type thin film transistor TFT1 for instance. The P-type thin film transistor TFT1 is used to drive the OLED. The gate G1 of each P-type thin film transistor TFT1 is respectively electrically connected to the corresponding drain D2 of the thin film transistor TFT2. Each source S1 is coupled to the constant voltage Vdd, and each drain D1 end is respectively electrically connected to the corresponding positive end of the light emitting diode OLED. Therefore, when the scan signal S is enabled, the thin film transistor TFT2 of each of the pixels 206 is also turned on. Meanwhile each of the storage capacitors Cs′(1)˜Cs′(N) respectively storage the magnitude of the voltage corresponding to the pixel data D.

According to the conventional design, all of the storage capacitors have the same capacitance value. Take the pixel array 202 of FIG. 4 for example, when all of the storage capacitors Cs′(1)˜Cs′(N) have the same capacitance value, the sum of all capacitors, for example the sum of the capacitors Cgs1, Cgs2, Cs' and Cgd (Cgs1+Cgs2+Cs′+Cgd) is almost the same for each pixel 206 when viewed from point A. Cgs2 is the parasitic capacitor between the gate G1 and the source S1 of the thin film transistor TFT1. Cgd is the parasitic capacitor between the gate G1 and the drain D1 of the thin film transistor TFT1. Therefore, the feed-through effect, which arises when the scan signal S is shifted to a low level from a high level, can be seen as having a uniform influence on the voltage level at point A inside the pixels 206 at the same row. This is elaborated in the following formulas.

At point X of FIG. 4, when the scan signal S is shifted to a low level from a high level, the change in voltage equals ΔV. The ΔV affects the voltage at point A inside each pixel 206 via the parasitic capacitor Cgs1 to change up to ΔVA which is expressed as:
ΔVA=[Cgs1/(Cgs1+Cgs2+Cs′+Cgd)]*ΔV.

The sum of the capacitors (Cgs1+Cgs2+Cs′+Cgd) is almost the same for each pixel 206 when viewed from point A and so is the Cgs1 inside each pixel 206 the same. When the scan signal is shifted to a low level from a high level, the resulted voltage drop ΔVA at point A inside each pixel 206 is also the same. However, the thin film transistor TFT2 of the pixel 206(N), which is farthest from the input end of the scan signal S, is turned off later due to the distortion in the waveform of the scan signal S. Consequently, the voltage on the data line DL′(N) still has a short time to change the voltage on the storage capacitor Cs′(N). That is to say, the voltage change at point A of the pixel 206(N) equals ΔVA plus the voltage change on the storage capacitor Cs′(N) caused by the voltage on the data line DL′(N). Therefore, after the scan signal becomes disabled, the voltage level at point A of the pixel 206(N) is higher than that at point A of the pixel 206(1), enabling the voltage across the storage capacitor Cs′(N) to be different from the voltage across the storage capacitor Cs′(1). As a result, the farther from the input end IN of the scan signal S, the higher the voltage level at point A will be, causing the pixels at the two sides, that is, the pixel 206(1) and the pixel 206(N,) to have different luminance.

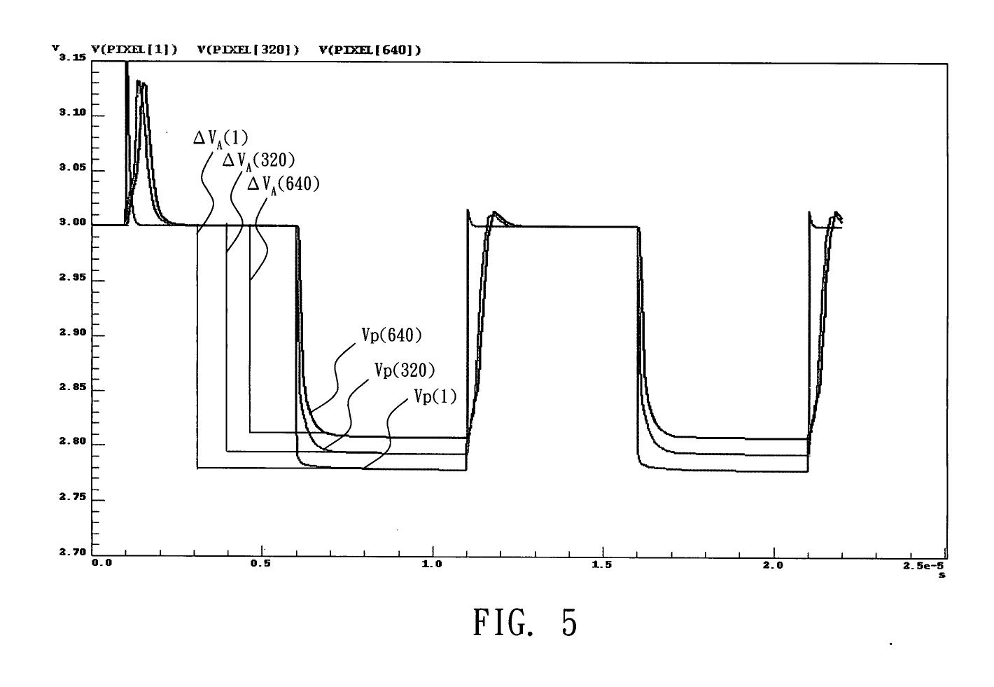

The voltage change at point A according to a conventional design is examined in the light of circuit simulation result. According to a conventional design, all of the storage capacitors have the same capacitance value. Referring to FIG. 5, a Pspice simulation result of voltage level change in point A according to a conventional method is shown. Let a scan line SL′ be electrically connected to 640 pixels 206, and let the parasitic capacitor existing between the scan line SL′ and the cathode be 0.06 pF, the resistance of the scan line SL′ be 20 ohms, the storage capacitor Cs' of each pixel 206 be 0.5 pF, the W/L ratio of the two thin film transistors TFT1 and TFT2 be 6 μm/6 μm, the high and the low voltage levels of the scan signal S respectively be +9V and −6V, and each pixel receive the same pixel data D.

In the above simulated terms, the capacitance value of each storage capacitor Cs' is the same, so the voltages Vp(1)˜Vp(N=640) at point A of each pixel 206 increase gradually. It can be seen in FIG. 5 that voltage Vp(1) is smaller than Vp(320), and Vp(320) is smaller than Vp(640).

According to the design of the embodiment according to the invention, the capacitance value of each storage capacitor Cs' is adjusted. For example, the capacitance value starts to decrease from the input end IN of the scan signal to change the situation that the voltage drop ΔVA at point A is the same to all of the pixels 206 when the scan signal S is shifted to a low level from a high level. The pixel 206(N) farthest from the input end IN of the scan signal receives even larger feed-through effect from the scan signal S so as to compensate the change the change in the voltage on the storage capacitor Cs′(N) of the pixel 206(N) caused by the voltage on the data line DL′(N).

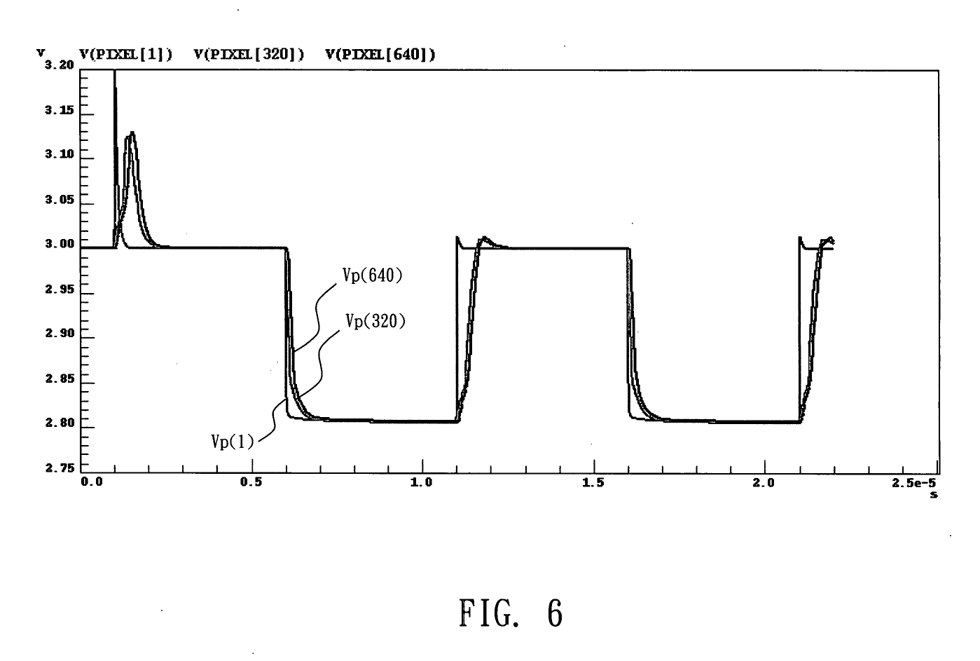

Referring to FIG. 6, a Pspice simulation result of voltage level change in point A according to an embodiment of the invention is shown. The present simulation differs with that of FIG. 5 in that the capacitance value for each storage capacitor Cs' is different. For example, the capacitance value linearly decreases by 1.3×10-16F from the input end IN of the scan signal along the scan line. That is, the capacitance value of the storage capacitor Cs′(1) equals 0.5 pF, the capacitance value of the Cs′(320) equals 0.5 pf−(320−1)×(1.3×10−16F), and the capacitance value of the Cs′(640) equals 0.5 Pf−(640−1)×(1.3×10−16F). As a result, it can be seen from FIG. 6 that the voltages Vp(1), Vp(320) and Vp(640) at point A of the pixels 206(1)˜206(N=640) are almost the same. In terms of the pixels 206 controlled by the same scan signal S, the problem of non-uniform luminance occurring to the pixels positioned at the two sides of the scan line due to the distortion in the waveform of scan signal S is largely mitigated, resulting in more uniformly distributed luminance on the display.

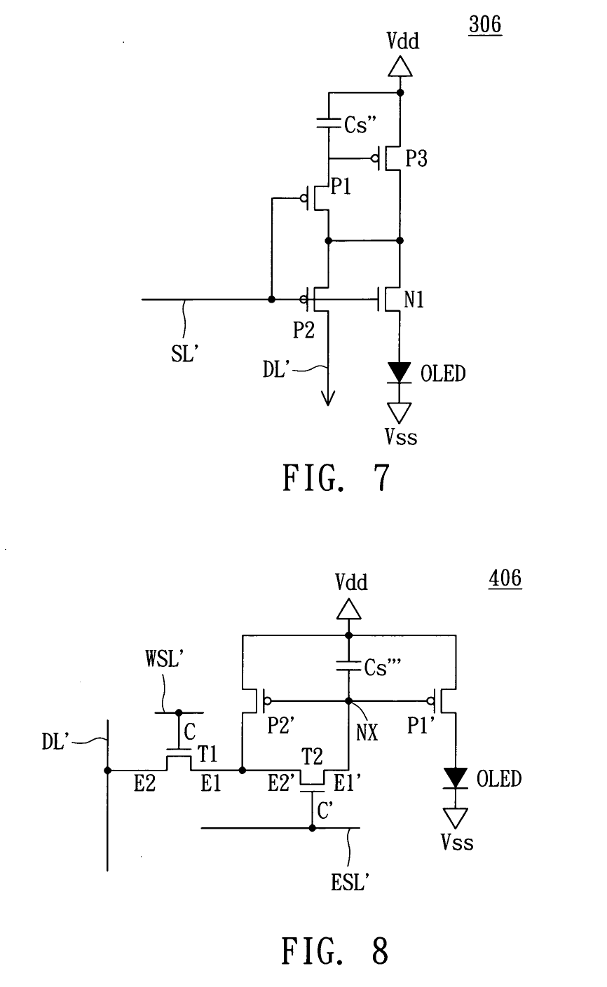

Apart from that, the invention is also applicable to the current driven pixel. Referring to FIG. 7, a circuit diagram of an example of a current-driven pixel is shown. Each of the pixels 306 includes an electroluminescent device, a first P-type TFT P1, a second P-type TFT P2, a third P-type TFT P3 and an N-type TFT N1. Like the above disclosure, the electroluminescent device is not limited to a PLED or an OLED. Take the OLED for example. The light emitting diode OLED has a positive end and a negative end. The negative end is coupled to a low voltage level Vss. The gate of the first P-type TFT P1 is electrically connected to the scan line SL′, and the source of the first P-type TFT P1 is coupled to the constant voltage level Vdd via the corresponding storage capacitor Cs″.

The gate of the second P-type TFT P2 is electrically connected to the scan line SL′, the source of the second P-type TFT P2 is electrically connected to the drain of the first P-type TFT P1, and the drain of the second P-type TFT P2 is electrically connected to the data line DL′. The gate of the third P-type TFT P3 is electrically connected to the source of the first P-type TFT P1, the source of the third P-type TFT P3 is coupled to constant voltage Vdd, and the drain of the third P-type TFT P3 is electrically connected to the drain of the first P-type TFT P1.

The gate of the N-type TFT N1 is electrically connected to the scan line SL′, the drain of the N-type TFT N1 is electrically connected to the drain of the third P-type TFT P3, and the source of the N-type TFT N1 is electrically connected to the positive end of the light emitting diode OLED.

Similarly, the N pixels 306 are electrically connected to the same scan line SL′, so that the capacitance value of each of the storage capacitors Cs″(1)˜Cs″(N) is adjusted according to the corresponding change in the voltage of the storage capacitor Cs″ caused by the distortion of the scan signal. For example, the capacitance value sequentially decreases from the input end IN of the scan signal. Consequently, after the scan signal is shifted to a low voltage level, the voltage difference among the storage capacitors Cs″ are further reduced, enabling the pixels of the same row to have a more uniform distribution of luminance.

Referring to FIG. 8, a circuit diagram of another example of a current-driven pixel is shown. The scan line SL′ further includes a write scan line WSL′ and an erase scan line ESL′. Each of pixels 406 includes a first switch T1, a second switch T2, a first P-type TFT P1′ and a second P-type TFT P2′.

The first switch T1 has a first switch's first end E1, a first switch's second end E2 and a first switch control end C. The first switch control end C is electrically connected to the write scan line WSL′. The first switch's second end E2 is electrically connected to the corresponding data line DL′.

The second switch T2 has a second switch's first end E1′, a second switch's second end E2′ and a second switch control end C′. The second switch control end C′ is electrically connected to the erase scan line ESL′. The second switch's first end E1′ is electrically connected to the node NX. The node NX is coupled to constant voltage Vdd via the storage capacitor CS′″. The second switch's second end E2′ is electrically connected to the first switch's first end E1.

The gate of the first P-type TFT P1′ is electrically connected to the node NX, the source S of the first P-type TFT P1′ is coupled to constant voltage Vdd, and the drain D of the first P-type TFT P1′ is electrically connected to the light emitting diode OLED. The gate G of the second P-type TFT P2′ is electrically connected to the node NX, and the source S of the second P-type TFT P2′ is electrically connected to the constant voltage Vdd. The drain D of the second P-type TFT P2′ is electrically connected to the first switch's first end.

Similarly, as long as one end of the storage capacitor Cs′″ coupled to the TFT, the second switch T2 for instance, is controlled by the scan signal when the N pixels 406 are electrically connected to the scan lines WSL′ and ESL′, the capacitance value of each of the storage capacitors Cs′″(1)˜Cs′″(N) is adjusted according to the corresponding change in the voltage of the storage capacitor Cs′″ caused by the distortion of the scan signal. For example, the capacitance value sequentially decreases from the input end IN of the scan signal. Consequently, after the scan signal is shifted to a low voltage level, the voltage difference among the storage capacitors Cs′″ are further reduced, enabling the pixels of the same row to have a more uniform distribution of luminance.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electroluminescence display, comprising:
a plurality of data lines;
a scan line having an input end;
a plurality of pixels, each pixel being electrically connected to the scan line and the corresponding data line and having a storage capacitor with a corresponding capacitance value different from those of the other pixels;
a scan driving circuit for providing a scan signal to the input end of the scan line to drive the pixels accordingly; and
a data driving circuit for providing pixel data to the data lines, wherein the pixel data are applied to the corresponding pixels as the scan signal is enabled.

2. The electroluminescence display according to claim 1, wherein the plurality of pixels comprise N pixels, the capacitance value of the storage capacitor of the I-th pixel of the N pixels is larger than the capacitance value of the storage capacitor of the J-th pixel of the N pixels, where 1≦I<J≦N, and the I-th pixel is closer to the input end of the scan line than the J-th pixel is.

3. The electroluminescence display according to claim 2, wherein the capacitance values of the storage capacitors decrease linearly along the scan line.

4. The electroluminescence display according to claim 1, wherein each of the plurality of pixels comprises:
a light emitting diode having a positive end and a negative end coupled to a low voltage level;
a switch device having a first end electrically connected to the corresponding data line, a second end coupled to a constant voltage level via the corresponding storage capacitor, and a control end electrically connected to the scan line; and
a thin film transistor(TFT) having a gate electrically connected to the second end of the switch device, a drain and a source, wherein one of the drain and the source is coupled to the constant voltage level, and the other is electrically connected to the positive end of the light emitting diode.

5. The electroluminescence display according to claim 1, wherein each of the plurality of pixels comprises:
a light emitting diode having a positive end and a negative end coupled to a low voltage level;
a switch device having a first end electrically connected to the corresponding data line, a second end coupled to a constant voltage level via the corresponding storage capacitor, and a control end electrically connected to the scan line; and
a P-type TFT having a gate electrically connected to the second end of the switch device, a source coupled to the constant voltage level, and a drain electrically connected to the positive end of the light emitting diode.

6. The electroluminescence display according to claim 1, wherein each of the plurality of pixels comprises:
a light emitting diode having a positive end and a negative end coupled to a low voltage level;
a first P-type TFT having a gate electrically connected to the scan line, a source of the first P-type TFT coupled to a constant voltage level via the corresponding storage capacitor;
a second P-type TFT having a gate electrically connected to the scan line, a source electrically connected to the drain of the first P-type TFT, and a drain electrically connected to the corresponding data line;
a third P-type TFT having a gate electrically connected to the source of the first P-type TFT, a source coupled to the constant voltage, and a drain electrically connected to the drain of the first P-type TFT; and
an N-type TFT having a gate electrically connected to the scan line, a drain electrically connected to the drain of the third P-type TFT, and a source electrically connected to the positive end of the light emitting diode.

7. The electroluminescence display according to claim 1, wherein the scan line further comprises a write scan line and an erase scan line, each of the plurality of pixels comprises:
a first switch having a first end, a second end electrically connected to the corresponding data line, and a control end electrically connected to the write scan line;
a second switch having a first end electrically connected to a node coupled to a constant voltage via the storage capacitor, a second end electrically connected to the first end of the first switch, and a control end electrically connected to the erase scan line;
a first P-type TFT having a gate electrically connected to the node, a source coupled to the constant voltage, and a drain electrically connected to the light emitting diode; and
a second P-type TFT having a gate electrically connected to the node, a source electrically connected to the constant voltage, and a drain electrically connected to the first end of the first switch.

8. The electroluminescence display according to claim 1, wherein each of the plurality of pixels comprises a polymer organic light emitting diode (PLED) or an OLED.

9. A pixel array of electroluminescence display, wherein the electroluminescence display comprises a data driving circuit and a scan driving circuit, the pixel array comprises:
a plurality of data lines electrically connected to the data driving circuit;
a scan line having an input end electrically connected to the scan driving circuit; and
a plurality of pixels, each pixel being electrically connected to the scan line and the corresponding data line and having a storage capacitor with a corresponding capacitance value different from those of the other pixels.

10. The pixel array according to claim 9, wherein the plurality of pixels comprise N pixels, the capacitance value of the storage capacitor of the I-th pixel of the N pixels is larger than that of the J-th pixel of the N pixels, where 1≦I, J≦N, and the I-th pixel is closer to the input end of the scan line than the J-th pixel is.

11. The pixel array according to claim 9, wherein the capacitance values of the storage capacitors decrease linearly along the scan line.

12. The pixel array according to claim 9, wherein each of the plurality of pixels comprises:
a light emitting diode having a positive end and a negative end coupled to a low voltage level;
a switch device having a first end electrically connected to the corresponding data line, a second end coupled to a constant voltage level via the corresponding storage capacitor, and a control end electrically connected to the scan line; and
a TFT having a gate electrically connected to the second end of the switch device, a drain and a source, wherein one of the drain and the source is coupled to the constant voltage level, and the other is electrically connected to the positive end of the light emitting diode.

13. The pixel array according to claim 9, wherein each of the plurality of pixels comprises:
a light emitting diode having a positive end and a negative end coupled to a low voltage level;
a switch device having a first end electrically connected to the corresponding data line, a second end coupled to a constant voltage level via the corresponding storage capacitor and a control end electrically connected to the scan line; and
a P-type TFT having a gate electrically connected to the second end of the switch device, a source coupled to the constant voltage level, and a drain electrically connected to the positive end of the light emitting diode.

14. The pixel array according to claim 9, wherein each of the plurality of pixels comprises:
a light emitting diode having a positive end and a negative end coupled to a low voltage level;
a first P-type TFT having a gate electrically connected to the scan line, and a source coupled to the constant voltage level via the corresponding storage capacitor;
a second P-type TFT having a gate electrically connected to the scan line, a source electrically connected to the drain of the first P-type TFT, and a drain electrically connected to the corresponding data line;
a third P-type TFT having a gate electrically connected to the source of the first P-type TFT, a source coupled to the constant voltage, and a drain electrically connected to the drain of the first P-type TFT; and
an N-type TFT having a gate electrically connected to the scan line, a drain electrically connected to the drain of the third P-type TFT, and a source electrically connected to the positive end of the light emitting diode.

15. The pixel array according to claim 9, wherein the scan line further comprises a write scan line and an erase scan line, each of the plurality of pixels comprises:
a first switch having a first end, a second end electrically connected to the corresponding data line, and a control end electrically connected to the write scan line;
a second switch having a first end electrically connected to a node coupled to a constant voltage via the storage capacitor, a second end electrically connected to the first end of the first switch, and a control end electrically connected to the erase scan line;
a first P-type TFT having a gate electrically connected to the node, a source coupled to the constant voltage, and a drain electrically connected to the light emitting diode; and
a second P-type TFT having a gate electrically connected to the node, a source electrically connected to the constant voltage, and a drain electrically connected to the first end of the first switch.

16. The pixel array according to claim 9, wherein each of the plurality of pixels comprises a PLED or an OLED.
